(19) United States
(12) Patent Application Publication
(10) Pub. No.: US 2003/0226476 A1
(43) Pub. Date: Dec. 11, 2003

(54) Method for producing basalt flaky filler for composites

(76) Inventor: Vera Vasilyevna Efanova, Kiev (UA)

Correspondence Address: ABELMAN, FRAYNE & SCHWAB, 26th Floor, 150 East 42nd Street, New York, NY, 10017, US

(21) Appl. No.: 10/366,055

(22) Filed: Feb. 13, 2003

Related U.S. Application Data
(63) Continuation-in-part of application No. 09/673,484, filed on Dec. 13, 2000, now abandoned.

(51) Int. Cl. C09C 1/22; B29B 9/00

(52) U.S. Cl. 106/456; 106/459; 106/483; 264/5; 264/12

(57) ABSTRACT

A method produces basalt flaky filler for composites by crushing and melting basalt, shaping hard flaky vitreous particles from the melt, and subjecting such particles to thermochemical treatment in an oxidizing atmosphere until a crystal phase is developed, with the thermochemical treatment the flaky particles performed at a temperature ranging from about 680° C. to about 850° C. until at least about 12% by weight of the crystal phase is obtained, and at least 7×10¹⁹ spin/cm³ of the reactive paramagnetic centers are developed, followed by air cooling of the flakes to form the filler.

### CROSS-REFERENCE TO RELATED APPLICATIONS

This application is a continuation-in-part of U.S. application Ser. No. 09/673,484, filed Dec. 13, 2000, now abandoned.

### BACKGROUND OF THE INVENTION

1. Field of the Invention

This invention relates to a method for producing dispersible basalt flaky materials for use as flaky fillers.

2. Description of the Related Art

It is well established that such flaky materials can be used as reactive fillers for composites, preferably polymerizable composites in preparing both protective and ornamental coatings featuring high weather resistance and water resistance (in protecting metal tanks, bridges, offshore drilling platforms, etc.) and/or abrasion resistance (for example, sludge lines).

Such fillers are in great demand. Accordingly, such fillers must satisfy a number of requirements that are getting more exact and are not easily combinable. These fillers are desirable to be:

a) as reactive as possible, the property being determined from at least the surface area and preferably by the presence of the active centers over the surface of such flakes, with the active centers constituting a contributory factor in polymerization of oligomeric binders and in establishing chemical interconnection between macromolecules and inorganic components;

b) as mechanically strong as possible thus providing an appreciable reinforcement in prepared composites even with low concentrations of the flaky fillers;

c) as chemically stable as possible (specifically, to be corrosion resistant) to ease up storage and the use of the flakes in preparing many types of composites which usually contain corrosive ingredients while in a green or initial state; and

d) commercially available to a variety of customers as a result of large-scale production and low cost.

These requirements taken separately are not too difficult to meet.

U.S. Pat. No. 4,363,889, for example, discloses a commercially available and somewhat reactive filler for polymerizable composites, prepared as glass flakes of a thickness ranging from 0.5 μm. to 5.0 μm., and from 100 μm. to 400 μm. in diameter or as a mixture of from 10 parts to 70 parts by weight of such flakes and from 10 parts to 150 parts by weight of flaky metallic pigments.

Glass flakes are extremely breakable and feature low surface reactivity unless subjected to an additional treatment (for example, vacuum metallization), while metallic flakes of highly developed surface area are not corrosion stable.

Also known in the art are flaky fillers such as micaceous iron oxide pigments (E. Carter, “Micaceous iron oxide pigments in high performance coatings”, POLYMER PAINT COLOUR JOURNAL, 1986, Vol. 176, No. 4164, pp. 226, 228, 230, 232, 234). Compared to glass flakes, they are more durable and chemically stable.

However, such fillers are costly, and that is why their use is advisable in applying protective coatings only to such articles and structures where the costs of failure are substantially higher than those of protecting arrangements.

It is, therefore, believed that one of the most preferable ways of providing flaky fillers intended mainly for use in polymer composites is to use flakes produced from natural minerals.

The present inventor has been involved as a joint originator in developing a technological package including:

a) a process for the production of finely-dispersed flakes (SU Patent Number 1,831,856);

b) an apparatus for producing finely-dispersed flakes (SU Patent Number 1,823,293); and

c) a method of heat treatment of finely-dispersed flakes and an apparatus for carrying out the method (RU Patent Number 2,036,748).

SU Patent Number 1,831,856 discloses a method for producing a basalt flaky filler by melting the basalt and dispersing the melt to produce ellipsoidal flakes. Microscopically analyzed for their shape and dimensions, the flakes are characterized in terms of the ratio between the minor and the major axes of an ellipse, by a distortion from the circular shape within ratios of 0.80 and 0.95.

Such flakes remain in the vitreous state and are chemically unstable, specifically due to the presence of lower oxides of iron, inherent in basalt used as a raw material. The flakes have low chemical activity.

SU Patent Number 1,823,293 teaches the manufacture of a basalt flaky filler by substantially the same process and this filler compared with the above-described one is more acceptable as regards to its particle size; namely, it contains up to 99% flakes of substantially identical form and size. However, these flakes again remain in the vitreous state, are chemically unstable, and have low chemical activity.

These disadvantages are noticeably eliminated in the method for producing of a basalt flaky filler bearing closely on the process disclosed in RU Patent Number 2,036,748.

According to the process disclosed in RU Patent Number 2,036,748, a basalt flaky filler is formed by melting a basalt as the starting mineral, shaping hard vitreous flaky particles from the melt, and subjecting such particles to thermochemical treatment in an oxidizing atmosphere until a substantially crystal structure is developed. The thermochemical treatment includes heating vitreous particles at the rate of 40° C./min. to 190° C./min. to a temperature of 600° C. to 950° C. with simultaneously air blowing for 5 min. to 30 min., followed by induced cooling at the rate at least 950° C./min. The basalt flaky filler treated as above contains substantially no FeO and exhibits high (at least 3 g/cm³) density which is higher than that of vitreous particles by the factor 1.5, has higher percentage (up to 53% by weight) of a crystal phase (hereinafter “crystallinity”), and has noticeable amounts of chemically active paramagnetic centers (hereinafter PMC).

These advantages have provided for an appreciable improvement in the properties of polymerizable composites reinforced with the described basalt flakes and of protective and ornamental coatings produced therefrom, as per R. A. Vesselovsky, V. V. Yefanova, I. P. Petukhov, “Study of physical, chemical, thermodynamic and mechanical properties of interface layers in cross-linked polymers”, MECHANICS OF COMPOSITES, 1994, Vol. 30, No. 5, pp. 3-11.

However, it was subsequently found that this filler formed by prior art processes, such as described in RU Patent Number 2,036,748, has no more than 6×10¹⁹ spin/cm³ of PMC that are active in the process of polymerization of monomers and oligomers, as per V. V. Yefanova, “Study of the properties of a new activated basalt filler for coating applications”, ECOTECHNOLOGY AND SAVING OF RESOURCES, 1993, No. 5, pp. 67-72. In other words, the crystallinity mentioned above and chemical activity of the prior art filler are not in balance.

Moreover, the present inventor's unpublished experimental findings have proved that the quest for higher crystallinity of the basalt flaky filler is not justified on account of process efficiency as well. For example, the flakes subjected to thermochemical treatment for 30 minutes at temperatures close to the smallest value of the indicated temperature range, that is, slightly higher than 600° C., show neither a detectable crystallinity improvement nor a detectable increase in chemical activity, while an increase in the treatment time over 30 min. results in a decrease in the product output. A change-over to a relatively short-run (about 5 min. to 10 min.) thermochemical treatment at about 900° C., or still higher temperatures, has been surprisingly found open to uncontrolled revitrification and a decrease in the chemical activity of the particles, to be more readily perceived as the higher both the temperature of heating the particles and the rate of cooling the heat-treated particles occur. And finally, the rate of heating vitrified particles, prior to exposure thereof to a gaseous oxidant such as air, has appeared to virtually have no effect on the progress and result of the treatment. Consequently, use of additional process instrumentation will unjustifiably increase the cost of the end product.

### BRIEF SUMMARY OF THE INVENTION

Therefore, the technical problem underlying the present invention is to create a method for producing a basalt flaky filler for composites which will provide for increasing the crystallinity and chemical activity the filler.

To this end the invention is directed to a method for producing basalt flaky filler for composites, and to the basalt flaky filler produced by the method. The method includes the steps of:

(a) obtaining hard vitreous flakes by:

(a1) crushing basalt to sizes suitable for insertion into a melting furnace;

(a2) heating the crushed basalt to obtain a thin melt; and

(a3) breaking up a stream of the melt flowing through a heated die into hard vitreous flakes using a melt processor, such as a whirler and/or an airstream machine;

(b) thermochemical treatment of the hard vitreous flakes from step (a) in an oxidizing atmosphere at a temperature ranging from about 680° C. to about 850° C. until an incomplete crystallization occurs; that is, at least about 12% by weight of the crystal phase, and at least about 7×10¹⁹ spin/cm³ of the reactive PMC are developed; and

(c) followed by air cooling of the flakes.

The filler thus produced is mechanically strong due to an adequate degree of crystallization and, owing to the congruity of the crystallinity with the chemical activity, filler can be used as a highly effective mechanism for upgrading the quality of mainly thick (more than about 1 mm., and typically more than about 3 mm) protective, ornamental, and abrasion-resistant coatings by the use of preferably such binders that are produced by polymerization of monomers and/or oligomers.

It should be mentioned here that production costs were reduced due to a reduction in an investment in the heating, cooling, and control equipment as well as in the costs of power for the thermochemical treatment and for preparing and feeding the coolant. The end product is therefore commercially more readily available.

The present invention requires the thermochemical treatment step to be performed until an incomplete crystallization occurs; that is, at least about 12% by weight of the crystal phase, and at least about 7×10¹⁹ spin/cm³ of the reactive PMC are developed. Accordingly, the present invention does not limit the thermochemical treatment step to a duration of 5 min. to 30 min. resulting in the filler of having no more than 6×10⁹ spin/cm³ of PMC, such as the filler formed by the processes in RU Patent Number 2,036,748. Instead, the present invention continues the thermochemical treatment longer than about 5 min. to about 30 min. until the desired results of at least about 12% by weight of the crystal phase, and at least about 7×10¹⁹ spin/cm³ of the reactive PMC are developed.

The method according to the invention is further characterized by thermochemical treatment of the hard vitreous flakes in air at temperature from about 680° C. to about 780° C. that decreases the production costs additionally, thus providing advantages over the prior art, such as RU Patent Number 2,036,748, with the invention providing for the use of lower temperatures for forming the hard vitreous flakes while improving production.

In the end, the method according to the invention is characterized in that the flakes are additionally mechanically treated by fragmentation and separation according to size until a basalt flaky filler containing at least 30% of particles having a mean size of about 100 μm. across to the total amount of the particles, and at least 14×10¹⁹ spin/cm³ of the reactive PMC are obtained. The filler obtained by this method is preferred for use with polymerizable composites, and so the present invention thus provides further advantages over the prior art, such as RU Patent Number 2,036,748, with the invention providing for at least one additional process step for forming the hard vitreous flakes for additional uses with polymerizable composites.

### DETAILED DESCRIPTION OF THE INVENTION

The invention is further explained by way of general description and specific data of the experimentation on the method of producing a basalt flaky filler for polymerizable composites, including the values of physical and chemical properties obtained, examples of how the filler is used in polymerizable composites for application as protective coatings, and results of comparative tests on the composites for applying such coatings.

Generally, the method of producing the basalt flaky filler of the invention comprises the steps of:

(a) obtaining hard vitreous flakes by:

(a1) crushing basalt to sizes suitable for insertion into a melting furnace,

(a2) heating the crushed basalt to obtain a thin melt (specifically to a temperature ranging from about 1400° C. to about 1500° C.); and

(a3) breaking up a stream of the melt flowing through a heated die into hard vitreous flakes using a melt processor, such as a whirler and/or an airstream machine;

(b) thermochemical treatment of the vitreous flakes from step (a) in an oxidizing atmosphere (preferably in air) at a temperature ranging from about 680° C. to about 850° C. (preferably from about 680° C. to about 780° C.) until an incomplete crystallization occurs; that is, at least about 12% by weight of the crystal phase, and at least about 7×10¹⁹ spin/cm³ of the reactive PMC are developed; and

(c) followed by air cooling; and, optionally,

(d) mechanical treatment of the flakes, for example, by fragmentation and separation according to size, until a basalt flaky filler containing at least 30% of particles having a mean size of about 100 μm. across to the total amount of the particles and at least 14×10¹⁹ spin/cm³ of reactive PMC are obtained.

In the production of hard vitreous flakes, use was made of basalt containing about 10% FeO and obtained from the Kostopol deposits (located in Ukraine). The basalt was crushed, and the crushed matter of about 5 mm. to about 40 mm. in size was melted in a modified melting furnace similar to a quartz-glass furnace, in which heat is supplied by gas burners. The melt was heated to a temperature ranging from about 1400° C. to about 1450° C. to be extruded through a heated die of heat-resistant steel in a stream of about 8 mm. to about 10 mm. in diameter. The stream of the melt was broken up in a stream of cooling air by a melt processor, such as a whirler and/or an airstream machine, generally heated to about 1400° C.

The flakes obtained were colored gray, were about 3 μm. thick, and were from about 25 μm. to predominantly about 3 mm. in size across. To avoid breaking up or compacting, the flakes were carefully poured over underpans of heat-resistant steel in loose layers of about 80 mm. to about 100 mm. thick, placed into a muffle furnace, and subjected to thermochemical treatment in air at successive temperatures of about 660° C., about 680° C., about 750° C., about 850° C., and about 875° C. for about 90 min., about 60 min., about 30 min., about 20 min., and about 15 min., respectively, and then removed from the furnace and cooled to room temperature in air.

In the preferred embodiment, the present invention requires the thermochemical treatment step to be performed until an incomplete crystallization occurs; that is, at least about 12% by weight of the crystal phase, and at least about 7×10¹⁹ spin/cm³ of the reactive PMC are developed. Accordingly, the present invention does not limit the thermochemical treatment step to a duration of 5 min. to 30 min. resulting in the filler of having no more than 6×10¹⁹ spin/cm³ of PMC, such as the filler formed by the processes in RU Patent Number 2,036,748. Instead, the present invention continues the thermochemical treatment longer than about 5 min. to about 30 min. until the desired results of at least about 12% by weight of the crystal phase, and at least about 7×10¹⁹ spin/cm³ of the reactive PMC are developed.

The method according to the invention is further characterized by thermochemical treatment of the hard vitreous flakes in air at temperature from about 680° C. to about 780° C., for example, to prolong the thermochemical treatment until the desired results of at least about 12% by weight of the crystal phase, and at least about 7×10¹⁹ spin/cm³ of the reactive PMC are developed. Such reduced use of temperature decreases the production costs additionally, thus providing advantages over the prior art, such as RU Patent Number 2,036,748, with the invention providing for the use of lower temperatures for forming the hard vitreous flakes while improving production.

In the end, the method according to the invention is characterized in that the flakes are additionally mechanical treated by fragmentation and separation according to size until a basalt flaky filler containing at least 30% of particles having a mean size of about 100 μm. across to the total amount of the particles and at least 14×10¹⁹ spin/cm³ of the reactive PMC are obtained. The filler obtained by this method is preferred for use with polymerizable composites, and so the present invention thus provides further advantages over the prior art, such as RU Patent Number 2,036,748, with the invention providing for at least one additional process step for forming the hard vitreous flakes for additional uses with polymerizable composites.

After the step of thermochemical treatment was performed, samples of the flakes treated at the above described temperatures were analyzed for crystallinity and the PMC content by known conventional methods.

Crystallinity X is defined by the formula:

$$X = \frac{{ⅆ}_{tp} - {ⅆ}_{vp}}{{ⅆ}_{cp} - {ⅆ}_{vb}} * 100 \% ,$$

where dₜₚ is the density of the particles after treatment, dᵥₚ is the density of the vitreous particles, d_{cp} is the density of the crystal phase, and d_{vb} is the density of the vitreous body of the particles, and the crystallinity value is determined by substituting density values defined in xylene into the formula, as per G. A. Rashin, N. A. Polkovoi “Certain physicotechnical properties of stoneware defined”, GLASS AND CERAMICS, No. 10, 1963, pp. 11-14.

The PMC were counted by electron paramagnetic resonance (EPR) spectra in a basalt flaky filler and diphenylpicrylhydrazine, the latter being a reference substance, as per “Electron Paramagnetic Resonance”, AN ABRIDGED CHEMICAL ENCYCLOPEDIA, Vol. V, Moscow: Soviet Encyclopedia, pp. 961-968.

The EPR-spectra were obtained from the model E/x-2547 radio spectrometer commercially available from the RADIOPAN company, located in Poland.

The analysis findings are summarized in Table 1.

TABLE 1
CRYSTALLINITY AND PARAMAGNETIC CENTERS
VS. TREATMENT TEMPERATURE

| | Treatment temperatures, ° C. | | | | |
|---|---|---|---|---|---|
| Indicators* | 660 | 680 | 750 | 850 | 875 |
| Crystallinity, % by wt. | 5.8 | 14.8 | 35.2 | 52.3 | 49.8 |
| PMC, 10¹⁹ spin/cm³ | 5.8 | 16 | 18 | 19 | 17 |

*Note: the respective indicators would constitute about 0.0% crystallinity and below about 2.0×10¹⁹ spin/cm³ for vitreous particles prior to the thermochemical treatment, and about 51.5% crystallinity and about 6.0×10¹⁹ spin/cm³ for prior art particles after thermochemical treatment at about 900° C., when essentially all the FeO has changed to Fe₂O₃.

As will be seen from Table 1, thermochemical treatment of the vitreous particles at temperatures below about 680° C. is not practicable since both crystallinity and PMC increase but significantly, nor it is practicable at temperatures above about 850° C. because crystallinity and PMC begin, though insignificantly, to be adversely affected.

Following thermochemical treatment to obtain at least about 12% by weight of the crystal phase, and at least about 7×10¹⁹ spin/cm³ of the reactive PMC, the basalt flaky filler was crushed and separated according to the particle size to thereby increase reactivity of the filler. The experiments were performed on the particles treated at about 750° C. Samples containing various proportions of particles with a mean size of about 100 μm. across were prepared and the number of PMC was determined. The results of the experiments are shown in Table 2.

TABLE 2
PARAMAGNETIC CENTERS
VS. MEAN PARTICLE SIZE ACROSS IN SAMPLES

| | Particles with mean size across below | | | | | |
|---|---|---|---|---|---|---|
| | 100 μm., % | | | | | |
| | 5.0 | 10.0 | 20.0 | 30.0 | 40.0 | 80.0 |
| PMC, 10¹⁹ spin/cm³ | 90 | 210 | 280 | 370 | 560 | 630 |

To assess the effect of the basalt flaky filler of the invention on the physico-mechanical properties of polymerizable composites, standard samples were prepared. These samples were used in determining the adhesive strength, measured as a force required to separate a steel mushroom-like piece from the coating applied to a support also made of steel, the compressive strength, the tensile strength, the modulus of elasticity in lateral flexure, and the impact strength per unit area. Similar samples of the prior art filler were also prepared and used in concurrent tests, with the methods and equipment for running such tests being well known to those skilled in the art.

In the above tests, the filler of the invention (hereinafter referred to as “IF”) was prepared by the thermochemical treatment at about 680° C. prior to crushing and classification and therefore having the lowest crystallinity and PMC counts, while the prior art filler (hereinafter referred PF) was prepared at about 900° C. and had crystallinity and the PMC count close to maximum. A relatively simple mixture of acrylic monomers containing polymeric additives and an initiator of polymerization, which are listed in the left column of Table 3, were used as a binder for experimental cold polymerizable composites.

TABLE 3
COMPOSITION OF EXPERIMENTAL
POLYMERIZABLE COMPOSITES

| Ingredients | Amount, parts by wt. |
|---|---|
| Methyl methacrylate | 100 |
| Polybutyl methacrylate | 20 |
| Polyvinyl chloride | 20 |
| Polyisocyanate | 15 |
| Benzoyl peroxide* | 10* |
| Dimethyl anyline | 3 |
| IF or PF | 10 |

*Note: benzoyl peroxide is used in a paste form as a mixture with dimethyl phtalate in approximate ratio by weight of 1:1.

The ingredients were proportioned, and then methyl methacrylate, polybutyl methacrylate, and polyvinyl chloride premixed. Then, one of the fillers was introduced, with stirring of the mix being performed, with polyisocyanate and dimethyl anyline then added (again with stirring), and lastly benzoyl peroxide was introduced. After a thorough mixing, the compositions were shaped in a conventional way into as many samples as required to obtain data on the physico-mechanical properties of the composites, the mean square deviation being about ±5%.

The findings are summarized in Table 4.

TABLE 4
COMPARISON OF SAMPLES TESTED

Filler

| Properties | IF | PF |
|---|---|---|
| Adhesive strength, MPa | 42 | 27 |
| Compressive strength, MPa | 92.0 | 72.0 |
| Tensile strength, MPa | 14.0 | 9.2 |
| Modulus of elasticity in | 36.4 | 28.5 |
| lateral flexure, MPa | | |
| Impact strength, kJ/m² | 17.3 | 14.2 |

As can be seen from in Table 4 the basalt flaky filler according to invention is more efficient compared with the prior art filler.

### INDUSTRIAL APPLICABILITY

The industrial applicability of the basalt flaky filler stems from the above-disclosed characteristics in connection with both possible large-scale production and wide applications.

What is claimed is:

1. A method for producing basalt flaky filler for composites, the method comprising the steps of:
(a) obtaining hard vitreous flakes by:
(a1) crushing basalt to sizes suitable for insertion into a melting furnace;
(a2) heating the crushed basalt to obtain a thin melt; and
(a3) breaking up a stream of the melt flowing through a heated die into hard vitreous flakes by a whirler and/or an airstream;
(b) performing thermochemical treatment of the hard vitreous flakes from step (a) in an oxidizing atmosphere at temperature ranging from about 680° C. to about 850° C. until an incomplete crystallization of at least about 12% by weight of the crystal phase is obtained, and at least 7×10¹⁹ spin/cm³ of the reactive paramagnetic centers are developed; and
(c) air cooling the thermochemically treated flakes to form the basalt flaky filler.

2. The method according to claim 1 wherein the step (b) of performing the thermochemical treatment of the vitreous flakes is carried out in air at a temperature ranging from about 680° C. to about 780° C.

3. The method according to claim 1 further comprising the step of:
(c1) mechanical treating the thermochemically treated flakes by fragmentation and separation according to size until the basalt flaky filler containing at least about 30% of particles having a mean size of about 100 μm. across to the total amount of the particles and at least about 14×10¹⁹ spin/cm³ of the reactive paramagnetic centers are obtained.

4. The method according to claim 2 further comprising the step of:
(c1) mechanical treating the thermochemically treated flakes by fragmentation and separation according to size until the basalt flaky filler containing at least about 30% of particles having a mean size of about 100 μm. across to the total amount of the particles and at least about 14×10¹⁹ spin/cm³ of the reactive paramagnetic centers are obtained.

5. The basalt flaky filler formed by the method of claim 1.

6. The basalt flaky filler formed by the method of claim 2.

7. The basalt flaky filler formed by the method of claim 3.

8. The basalt flaky filler formed by the method of claim 4.
